(19) United States
(12) Patent Application Publication
(10) Pub. No.: US 2020/0056568 A1
(43) Pub. Date: Feb. 20, 2020

(54) A FUEL ATOMIZER AND A METHOD FOR ATOMIZING FUEL

(71) Applicant: Sky Fortune Star Technology Limited, Hong Kong (CN)

(72) Inventor: King Shing Tang, Hong Kong (HK)

(21) Appl. No.: 16/604,164

(22) PCT Filed: Apr. 2, 2018
(86) PCT No.: PCT/CN2018/081520

§ 371 Date: Oct. 10, 2019

(30) Foreign Application Priority Data
Apr. 10, 2017 (HK) 17103637.4

(51) Int. Cl. F02M 29/00; F02M 57/00

(52) U.S. Cl. CPC F02M 29/00; F02M 65/008; F02M 57/00

(57) ABSTRACT

A fuel atomizer (100) has a conduit (105) for passage of fuel (101) and an object (113) in the conduit (105) which creates continual and repetitive turbulence in the fuel (101). The turbulent fuel exits the conduit (105) via a nozzle (111) into a spray of fine mist (103). The object (113) is a movable magnet (601) which is repelled by another magnet (701) at the outlet (109) of the conduit (105). The flow of fuel (101) carries the movable magnet (601) towards the outlet (109) of the conduit (105) while the other magnet (701) repels the movable magnet (601) backwards. So the movable magnet (601) moves repetitively.

### FIELD OF INVENTION

The present invention relates to an atomizer for combustion engine fuels, such as gasoline and petrol.

### BACKGROUND OF THE INVENTION

Engine fuels such as gasoline are provided and stored in liquid form in fuel tanks of vehicles. For fuel to combust in an engine, the fuel must first be physically broken down into a fuel mist by a process called atomization. Fuel mist is in the liquid state but it has been dispersed into fine droplets. Such fuel in mist form can mix very well with air, which is critical for efficient combustion. Generally, the smaller the size of the droplets, the finer the mist and the greater the surface area of the fuel which can react with air directly.

There are two common ways to convert fuel into a mist and to introduce the mist into the combustion chamber of an engine. One way uses a carburettor and the other way, a fuel injector.

A carburettor is simply a conduit for air which is placed next to a small outlet of a fuel tank. The conduit has a small constriction somewhere along it, which increases the pressure and velocity of air passing through the constriction. The outlet of the fuel tank is positioned right at the constriction. Hence, fuel is drawn in by Venturi effect to disperse into the passing air. The fuel and air mixture is then drawn into the combustion chamber of the engine to combust.

A fuel injector relies on build up pressure in an injector head to push aside a pin which is in the way of the fuel to a nozzle. When the pressure is high enough to push aside the pin, the fuel escaping through the nozzle forces out in the form of a fine spray. The spray is directed to mix into pressurised air to combust.

With both carburettor and a fuel injector, the fuel can only be pressurized and atomized using the pressure created by the suction of the engine. Therefore, the engine capacity limits the extent of atomization. The same problem is found in both gasoline and petrol based engines. However, adding to this problem is the high pressure within engine combustion chambers, which acts somewhat to prevent the atomized fuel from mixing with air perfectly.

Furthermore, poor atomization of fuel is due partly to natural clustering of fuel molecules. Such fuel clusters do not separate readily, which is why high pressure is applied to break the clusters in fuel injectors.

Accordingly, it is desirable to provide an apparatus and/or a method for overcoming the limitations on fuel atomization caused by the typical engine design.

### SUMMARY OF THE INVENTION

In a first aspect, the invention proposes a fuel atomizer comprising a fuel flow path; and an object placed in the fuel flow path; the object arranged to move repeatedly in the fuel during passage of fuel.

The continual, repetitive movements of the object in the flow path create continual flow disturbance in the fuel, even as the fuel flows past the object. The disturbance physically agitates the fuel which helps clusters of fuel molecules to break apart, which increases the efficiency of atomization.

Preferably, the object is movable by the flow fuel in one direction but is also biased to move counter-currently to the flow of fuel in another direction. This allows the object to be capable of moving concurrent with the fuel and counter-current to the fuel in alternating successions.

Typically, the fuel flow path is defined by a conduit, and the object is secured to a wall of the conduit by a resilient member. The resilient member allows the object to move from an original position in the fuel flow path and then brings the object back into the original position, in continual successions.

Preferably, the object is a magnetic device, and the fuel atomizer further comprising a magnetic field having a polarity directed at the magnetic device in order to bias the magnetic device to move counter-currently to the flow of fuel, by repelling the magnetic device when the magnetic device is brought near the magnetic field by the flow of fuel. In this way, the magnetic device is able to move back and forth within the fuel flow path repetitively, continually driven by the fuel forward to the magnetic field and then repelled to move backward by the magnetic field. Using a magnetic field to repel the object obviates any need of a physical, resilient member to control the movements of the object.

Preferably, the magnetic device is a cylinder having a through-hole for passage of fuel through the magnetic device. This compels the fuel to flow into the through-hole as it passes through the fuel flow path. In a first stage, the magnetic device is carried by the fuel towards the magnetic field. At the same time, however, some of the fuel passes through the through-hole. Passing through the relatively small through-hole pressurises the fuel into a fuel mist. In a next stage, when the magnetic device has been carried by the fuel close to the magnetic field, the magnetic field repels the magnetic device to move backwards, counter-currently to the flow of fuel. The force of the through-hole moving counter-current against the on-coming fuel increases the pressure on the fuel passing into the through-hole. In other words, the effect of the magnetic device moving against fuel flow is such that fuel is forced into the through-hole is at a relatively velocity greater than the actual velocity of the flow of fuel in the fuel flow path. This causes an enhance pressurization of the fuel at the through-hole which cannot be achieved by the mere suction generated by the combustion chamber alone. Hence, an enhanced pressure is provided to break the fuel into a fine mist.

Preferably, the magnetic field is provided by a second magnetic device, the second magnetic device being in a position relatively fixed to the flow path. In some preferred embodiments, the second magnetic device is actually in the flow path. Alternatively, the second magnetic device is placed out of the flow path, such as being adjacent to the flow path. The magnetic field emitted by the second magnetic device transcends physical boundaries to act against the object in the flow path. An example of this is a magnetic collar placed around the flow path.

Preferably, the atomizer comprises flow guides for causing flow of fuel in the flow path to spin. For example, flow guides may be provided by a spiralling profile on the walls of a conduit defining the fuel flow path. The spiralling profile guides the fuel in the flow path to spin about an axis along the length of the flow path, even as the fuel moves through the flow path. This has an effect that the fuel continues to spin as the fuel leaves the fuel flow path. Even in an atomized state, the fuel mist can be seen spinning. A spinning atomized fuel mist which mixes more efficiently with air in the combustion chamber than an atomized fuel mist which does not spin.

Preferably, the atomizer further comprises fins for absorbing and directing heat into the fuel flow path. The fins are attached to the atomizer, outside of the fuel flow path. Generally, the fins simply extend from the atomizer. If the atomizer is installed onto a vehicle engine, heat emitting from the engine when the engine is running is absorbed by the fins. The heated fins transfer the heat to the fuel flow path. This heats up the fuel even as the fuel is moving in the fuel flow path, and being atomized. The heat excites the fuel molecules, which helps clusters of fuel molecules to break apart, enhancing atomization efficiency. Furthermore, when already pre-heated as the fuel mist is introduced into an engine's combustion chamber, the fuel mist would be more readily combustible, which provides improved combustion efficiency.

In a second aspect, the invention proposes a method of atomizing fuel comprising the steps of: providing a fuel flow path; providing a movable object placed in the fuel flow path, supplying fuel to flow through the fuel flow path; repetitively moving the movable object, such that movements of the movable object creates continual flow disturbances in the fuel as the fuel moves through the fuel flow path.

Typically, the method further comprises the steps of: moving the movable object concurrently with the flow of fuel, and then moving the movable object counter-currently to the flow of fuel.

Preferably, the step of moving the movable object counter-currently to the flow of fuel comprises a step of repelling the movable object by a magnetic field.

Preferably, the method further comprises spinning the fuel in the fuel flow path, the spinning typically being about an axis defined by the direction of fuel flow.

In a third aspect, the invention proposes a method of atomizing fuel comprising the step of moving an orifice for passage of fuel counter-currently to the flow of the fuel. The velocity of the fuel entering the orifice is therefore the velocity of the fuel minus the negative velocity of the movement of the hole. This provides a greater velocity of the fuel entering the orifice than that which is made possible merely by the flow of the fuel.

In a fourth aspect, the invention proposes a combustion engine comprising: a combustion chamber have an inlet; an atomizer connected to the inlet; wherein the atomizer comprises a fuel flow path; and an object placed in the fuel flow path; the object arranged to move repeatedly in the fuel during passage of fuel. Examples of such a combustion engine include a car engine, aeroplane engine, small devices engine such as lawn mower engines and so on.

In a fifth aspect, the invention proposes a combustion engine comprising: a combustion chamber having an outlet for residual fuel; a heated fuel flow path connected to the outlet. A heated path increases mobility of the fuel as the fuel is returned to storage. Heated fuel has greater mobility which enhances the movement of the residual fuel in the return path.

In a sixth aspect, the invention proposes a combustion engine comprising: a combustion chamber having an outlet for residual fuel; a fuel flow path for returning the residual fuel to a storage connected to the outlet; wherein a fuel atomizer is installed in the fuel flow path. Atomized fuel has greater mobility which enhances the movement of the residual fuel in the return path.

In the seventh place, the invention proposes an alloy for the body of an atomizer configured to transfer heat from the surroundings into a fuel to be atomized, the alloy being a zinc and copper alloy comprising 2% to 5% lead.

### BRIEF DESCRIPTION OF THE FIGURES

It will be convenient to further describe the present invention with respect to the accompanying drawings that illustrate possible arrangements of the invention, in which like integers refer to like parts. Other arrangements of the invention are possible, and consequently the particularity of the accompanying drawings is not to be understood as superseding the generality of the preceding description of the invention.

FIG. 1 is an illustration of an embodiment;

FIG. 2 shows the embodiment of FIG. 1 in use with a combustion engine;

FIG. 3 shows the embodiment of FIG. 1 in use with a combustion engine inside a vehicle;

FIG. 4 is an illustration of another embodiment;

FIG. 5 is an illustration of yet another embodiment;

FIG. 6 is an illustration of yet another embodiment;

FIG. 7 is an illustration of yet another embodiment;

FIG. 8 is an illustration of yet another embodiment;

FIG. 9 further illustrates the operation of the embodiment of FIG. 7;

FIG. 10 is an illustration of a preferred embodiment;

FIG. 11 is an alternative illustration of the preferred embodiment of FIG. 10;

FIG. 12 illustrates a part of the embodiment of FIG. 11;

FIG. 13 further illustrates the part of the embodiment of FIG. 11 shown FIG. 12;

FIG. 14 illustrates a part of the embodiment of FIG. 11;

FIG. 15 illustrates the part shown in FIG. 14 in the perspective;

FIG. 16 illustrates the part shown in FIG. 14 in the plan;

FIG. 17 illustrates the part shown in FIG. 14 in the plan;

FIG. 18 shows the embodiment of FIG. 11 in operation;

FIG. 19 illustrates a plurality of the embodiment of FIG. 11 in use together;

FIG. 20 illustrates the embodiment of FIG. 11 in use on a combustion engine of a vehicle; and

FIG. 21 is an illustration of another embodiment.

### DETAILED DESCRIPTION OF EMBODIMENTS

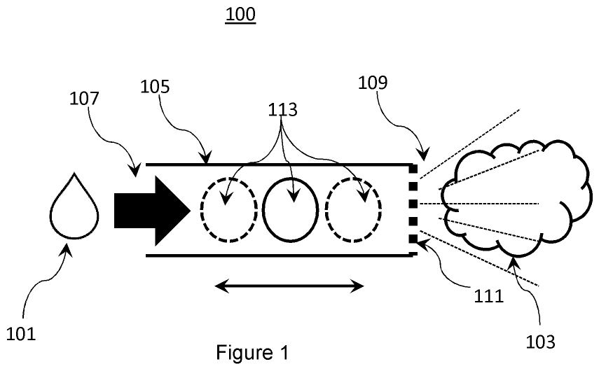

FIG. 1 is a simplified illustration of the sidewise cross-section of an embodiment of the invention, which is a fuel atomizer 100 for converting liquefied fuel 101 into a fuel mist 103. The fuel can be gasoline, petrol or any fuel fluid enough to be atomized into a mist form.

The atomizer 100 comprises a conduit 105 for passage of fuel 101. The fuel 101 flows from an inlet 107 to the conduit 105 to an outlet 109 of the conduit 105, due to a suction created by the combustion chamber of an engine to which the outlet 109 is connected. The outlet 109 of the conduit 105 is provided with a nozzle 111 comprising small holes which cause the fuel 101 leaving the conduit 105 to be dispersed in a pressurized spray, effectively breaking apart the fuel 101 physically into a fine mist 103 of fuel droplets. When the fuel 101 is provided in the form of a mist 103, the surface area for contacting air is increased. The mist of fuel 103 can therefore mix with air easily to combust efficiently. Within the conduit 105 is a flow-disturbance object 113 that is able to move back and forth in the conduit 105 to create turbulence in the fuel flow. The turbulence enhances the separation of clusters of fuel molecules, which provides the possibility of even finer fuel mist droplets when the fuel 101 emerges from the nozzle 111.

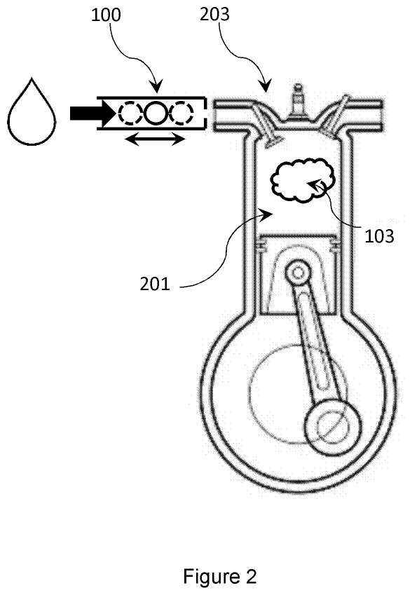

FIG. 2 illustrates a fuel mist 103 leaving the atomizer 100 and entering into the combustion chamber 201 of a combustion engine 203, in order to mix with air in the chamber 201 and to combust.

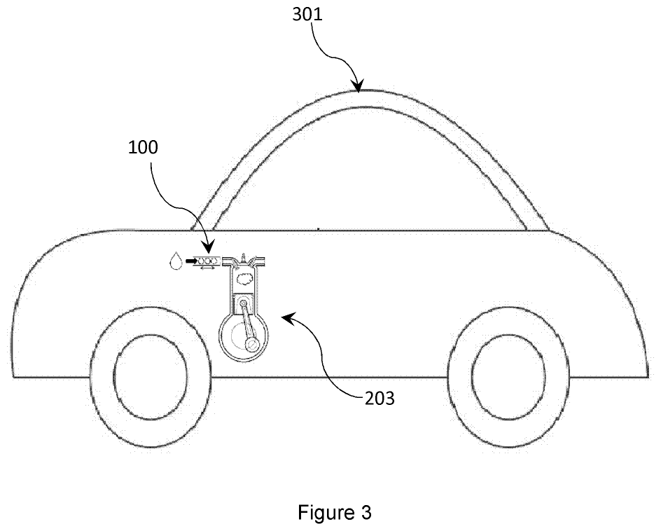

FIG. 3 illustrates the atomizer 100 connected to a combustion engine 203 and installed into a car 301.

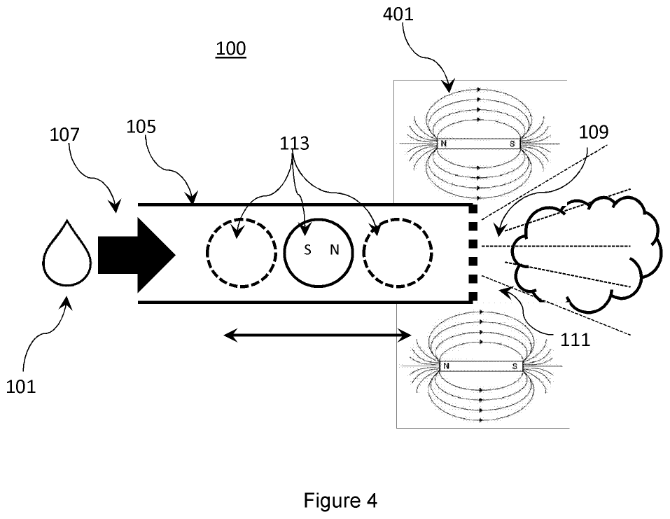

FIG. 4 shows another embodiment 100, which comprises a magnetic field 401 provided at the outlet 109 of the conduit 105. The flow-disturbance object 113 is also magnetic, and emits a magnetic field. The polarity of the magnetic field emitted by the flow-disturbance object 113 towards the outlet 109 is the same as the polarity of the magnetic field 401 at the outlet 109 emitted towards the flow-disturbance object 113. Therefore, whenever the flow-disturbance object 113 is carried by flowing fuel 101 close to the outlet 109, the flow-disturbance object 113 is repelled by the magnetic field 401 to move counter-currently to the flow of the fuel 101. In this way, the flowing fuel 101 and the magnetic field 401 cause the flow-disturbance object 113 to move back and forth in the conduit 105 repetitively. Typically, the repetition of the back and forth movements is very fast, and a person who is holding the atomizer 100 will feel a strong and high frequency vibration. The frequency of the vibration is variable by design, such as varying the strength of the magnetic field of the flow-disturbance object 113, the strength of the magnetic field 401 at the outlet 109, the flow of the fuel 101 which is in turn determined by the suction created by a combustion engine connected to the atomizer 100, the temperature of the fuel 100 which determines how fluid is the fuel, the size of the conduit 105, the size and weight of the flow-disturbance object 113, the number and size of the holes at the nozzle 111, and so on.

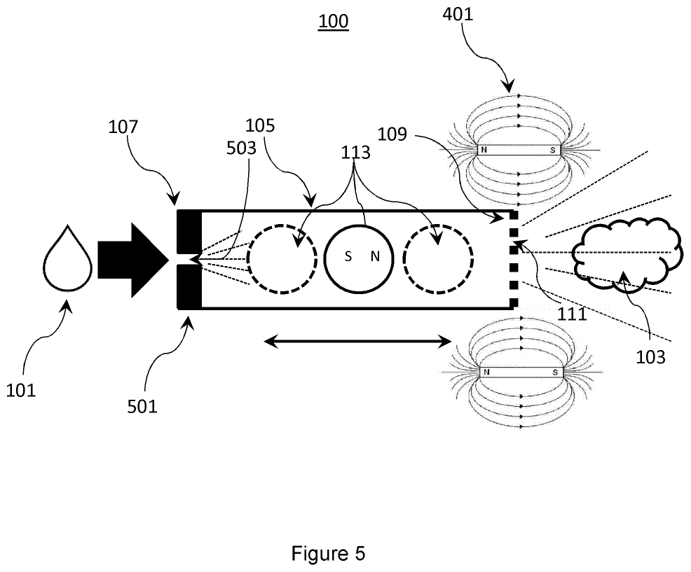

FIG. 5 shows yet another embodiment 100 wherein a stop 501 is provided at the inlet 107 to the conduit 105. The stop 501 prevents the flow-disturbance object 113 from being pushed too far away from the conduit outlet 109 by the repelling magnetic field 401. The distance between the stop 501 from the outlet 109 determines the distance in the conduit 105 in which the flow-disturbance object 113 may travel back and forth. This distance determines the frequency of movement repetition of the flow-disturbance object 113. The shorter the distance, the faster the flow-disturbance object 113 completes its move from one end to the other and begins travelling back to the starting end and, hence, the higher the frequency of movement repetition.

The stop 501 is preferably a ring which has a centre hole 503 to allow fuel 101 to pass through. The hole 503 provides a constriction to the fuel flowing into the conduit 105, which causes the fuel 101 to enter the hole 503 in increased pressure. This provides some extent of atomization as the fuel 101 passes into the conduit 105, to provide a preliminary mist of atomized fuel. The movements of the flow-disturbance object 113 in the preliminary mist of atomized fuel in the conduit 105 creates stirrings and turbulence in the preliminary mist of atomized fuel, which helps to break any fuel molecule clusters into smaller clusters. The fuel 101 is therefore atomized once on entry into the conduit 105 and atomized twice on exit from the conduit 105 through the nozzle 111. By the time the fuel 101 exits the outlet 109 of the conduit 105, the fuel 101 has become a very fine mist 103 which can mix very well with air in the combustion chamber 201.

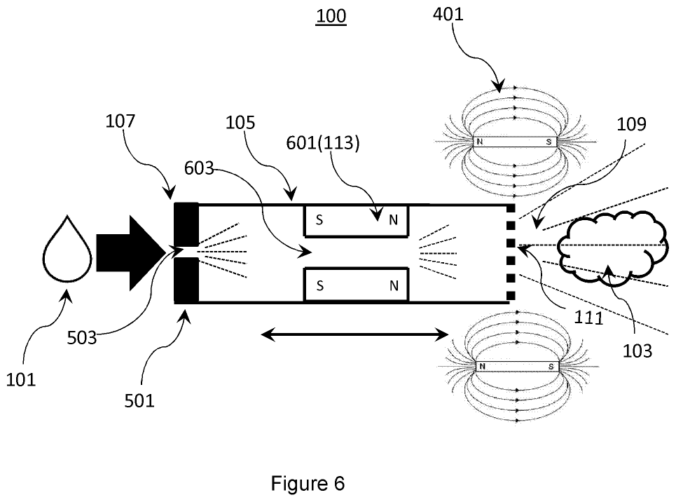

FIG. 6 shows a yet more preferable embodiment. The flow-disturbance object 113 is in the form of a movable cylinder 601 having a through-hole 603 through which fuel 101 in the conduit 105 passes. The movable cylinder 601 is movable in a fuel flow path defined by the conduit 105. The through-hole 603 provides yet another constriction to the moving fuel 101, which again pressurises the fuel 101 into a mist 103 when the fuel 101 enters into and exits from the through-hole 603. Hence, the centre hole 503 in the stop 501, the through-hole 603 in the movable cylinder 601, the quick successive, back and forth movements of the movable cylinder 601 in the conduit 105 and the holes in the nozzle 111 at the outlet 109 of the conduit 105, all contribute to breaking up the fuel 101 physically into a fine fuel mist 103.

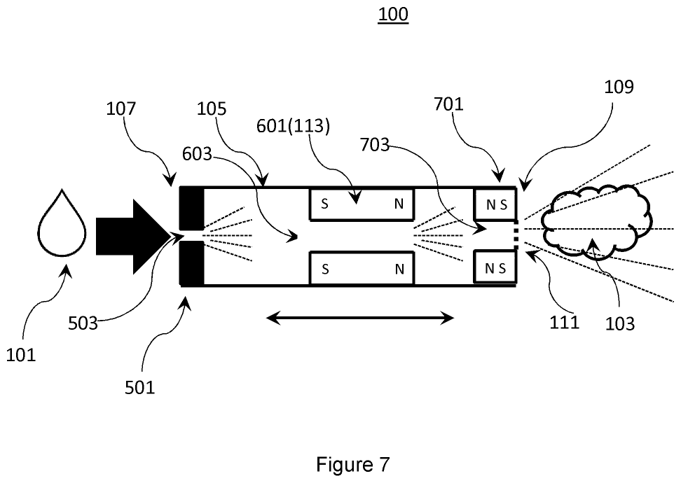

FIG. 7 shows a yet more preferable embodiment. The magnetic field 401 within the conduit 105 for opposing the flow-disturbance object 113 is provided in the form of a fixed magnetic cylinder 701, which is fixed in a position inside the conduit 105 near the conduit outlet 109. The flow-disturbance object 113, being a magnet in the form of the movable cylinder 601, will be repelled by the fixed magnetic cylinder 701 when flowing fuel 101 carries the movable cylinder 601 too close to the fixed magnetic cylinder 701. The fixed magnetic cylinder 701 has a cylinder bore 703 which allows passage of fuel 101 towards the nozzle 111, where the fuel 101 will exit the conduit 105 as an atomized spray. Hence, the centre hole 503 in the stop 501, the through-hole 603 in the movable cylinder 601, the quick successive, back and forth movements of the movable cylinder 601 in the conduit 105, the cylinder bore 703 of the fixed magnetic cylinder 701, and the holes in the nozzle 111 at the outlet 109 of the conduit 105, all contribute to breaking up the fuel 101 physically into a fine fuel mist 103.

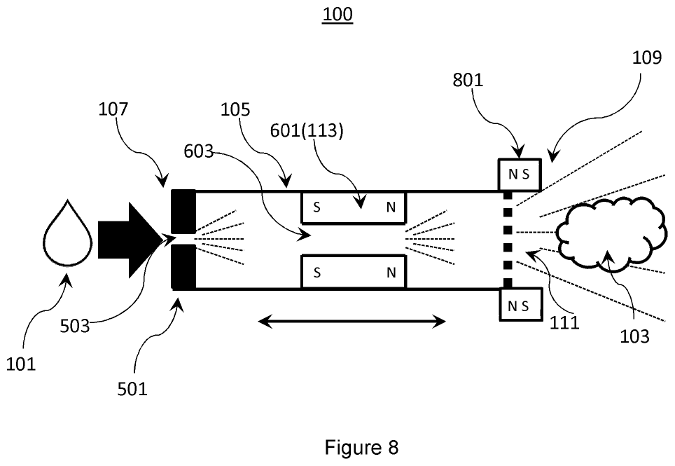

FIG. 8 shows a variation of the atomizer 100 of FIG. 7, wherein a fixed magnetic cylinder 801 with a relatively bigger diameter than the conduit's is placed over the conduit 105, that is, on the outside of the conduit 105, instead of inside the conduit 105 as in FIG. 7. In this case, there is no cylinder bore 703 for pressurising the exiting fuel 101; only the nozzle 111 holes provide the last stage of atomization in the atomizer 100.

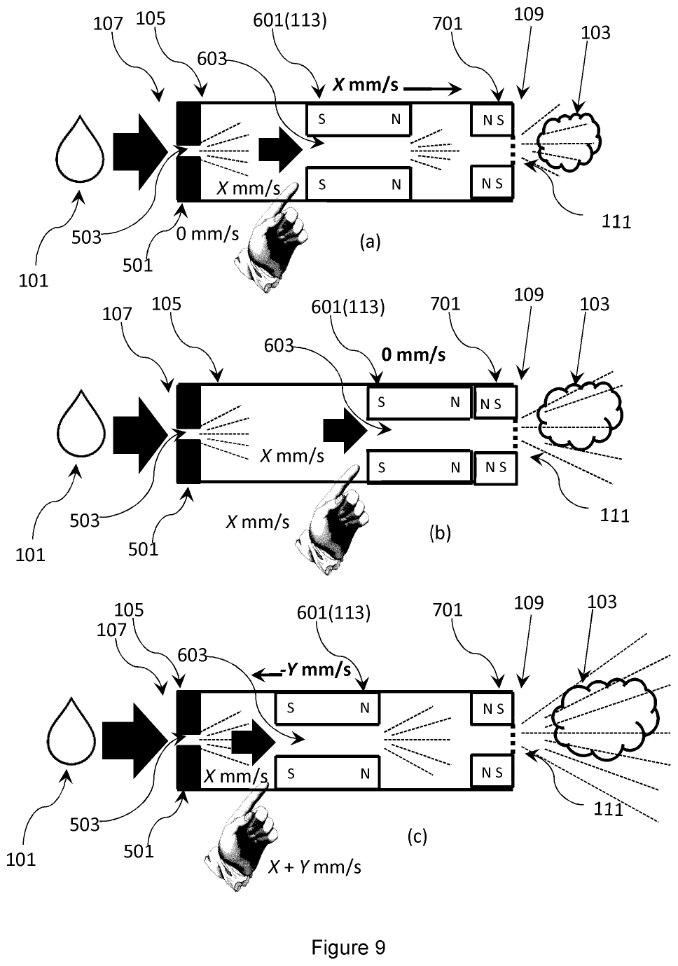

FIG. 9 explains how, in the atomizer 100 of FIG. 7, does the movable cylinder 601, being carried along by the flow of fuel 101 and being repelled to move counter-currently to the flow of fuel 101, contribute to atomization of fuel 101.
a) As shown in the top drawing in FIG. 9, if the flow velocity of the fuel 101 is x mm/s (see the image of the hand in the drawing), the movable cylinder 601 is carried along by the fuel 101 in the same velocity. The fuel 101 does not enter much into the through-hole 603, and the relative velocity of the fuel to the movable cylinder 601 is 0 mmm/s. However, fuel 101 on the right side of the movable cylinder 601, as shown in the drawing, is atomized on exiting the conduit 105 by the nozzle 111 at the conduit outlet 109.
b) As shown in the middle drawing in FIG. 9, when the movable cylinder 601 has moved so close to the fixed magnetic cylinder 701 and is met with an equal and opposite magnetic force, the movable cylinder 601 is momentarily stationary, at a velocity of 0 mm/s. In this instance, the pressure exerted on the fuel 101 as the fuel 101 enters the through-hole 603 is proportional to the fuel flow velocity of x mm/s. Hence, the fuel 101 exits the conduit 105 being subjected to the pressurizing constriction of the centre hole 503 in the stop 501, the through-hole 603 in the movable cylinder 601, the cylinder bore 703 of the fixed magnetic cylinder 701, and the holes in the nozzle 111 at the outlet 109 of the conduit 105, breaking up the fuel 101 physically into a fine fuel mist 103.
c) However, as shown in the bottom drawing in FIG. 9, when the movable cylinder 601 is repelled by the fixed magnetic cylinder 701 to move counter-current to the fuel flow, pressurisation of the fuel 101 as the fuel 101 enters the through-hole 603 in the movable cylinder 601 is determined by the fuel flow velocity of x mm/s and the reversed velocity of the movable cylinder 601 at −y mm/s. The effect of the magnetic device moving counter-current is such that fuel 101 is forced into the through-hole 603 is at a relatively velocity of x+y mm/s, which is greater than the actual velocity of the fuel 101 at x mm/s in the conduit 105. This enhanced pressurization of the fuel 101 cannot be provided merely by relying on the suction of the combustion chamber 201 of the engine alone, but by using in conjunction a through-hole 603 or some other sort of orifice moving counter-current to the fuel. Hence, a heightened force is provided, breaking apart the fuel 101 more efficiently. The finely atomized fuel leaving the through-hole 603 of the movable cylinder 601 is further atomized, when forced through the holes of the nozzle 111, giving a much enhanced atomized fuel mist 103.
In general, it has been found that the shorter the length of the movable cylinder 601, the more efficient the atomization provided by the through-hole 603. This is because if the through-hole 603 is too long, it causes a resistance to fuel flow. A shorter length of through-hole 603, moving back and forth in quick succession, gives better atomization result.

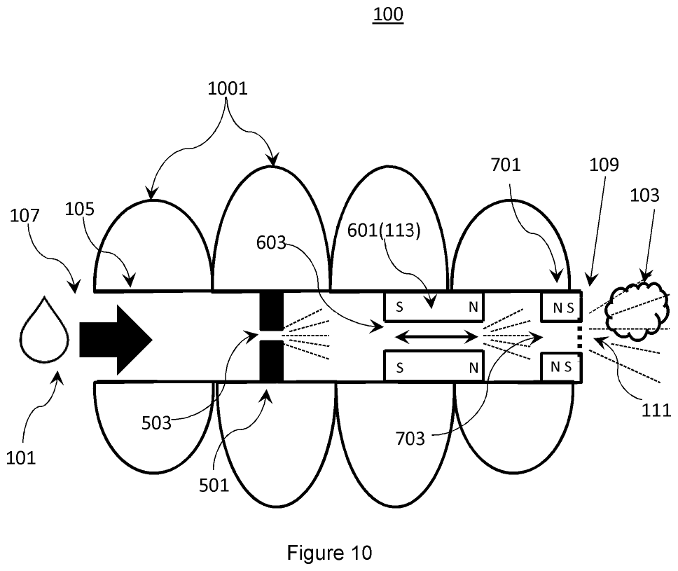

FIG. 10 shows yet another embodiment, in which the conduit 105 has an outer wall which is provided with fins 1001 for increased surface area. Conventionally, fins 1001 are provided to radiators which need to dispel heat quickly. In this case, however, the fins 1001 are provided to absorb heat. If the engine is in a car, the air in the hood of the car containing the engine would heat up as the car is driven. The large surface area of the fins 1001 absorbs this heat and directs the heat into the conduit 105 to heat up fuel 101 passing through the conduit 105. Unlike FIG. 7, the conduit 105 of FIG. 10 is longer and the stop 501 is somewhere in the middle of the conduit 105. However, the fins 1001 are provided from one end of the conduit 105 to the other. The supply of heat to fuel 101 before the fuel 101 passes the stop 501 helps to preheat the fuel 101 before the fuel 101 enters the part of the conduit 105 where the flow-disturbance object 113 resides.

The embodiment of FIG. 10 is preferably made of an alloy of zinc and copper, and the alloy contains a small portion of lead. Generally, the copper is about 35% wt to 40% wt and zinc about 60% wt to 55% wt, depending on the formulation. The remaining part of the alloy is made of lead about 2% wt to 5% wt. The proportion of copper to zinc is just generally 35:60 The important factor is the proportion of lead. It has been found that lead below 5% and above 2% gives superior absorption of surrounding heat and superior transfer of heat into the fuel flow path. Indirectly, use of the alloy to heat up fuel for combustion reduces the amount of pollutant output due to incomplete combustion in the combustion chamber by half.

FIG. 11 shows a preferable design of the atomizer 100. The fins 1001 are provided in rounded lumps in the form of two calabashes placed bottom to bottom, instead of thin fins 1001 extending away from the conduit 105 in the way fins 1001 normally are provided in radiators. This is because the purpose of the fins 1001 is to contact as much hot air around the atomizer 100 as possible to absorb heat, instead of dissipate heat into the surroundings.

FIG. 11 also shows how the fixed magnetic cylinder 701 and the movable cylinder 601 are both magnets in the same cylindrical forms. As shown in FIG. 11, the fixed magnetic cylinder 701 and the movable cylinder 601 can be identical in design.

Furthermore, FIG. 11 shows the stop 501 having an external surface lined with screw threads which may cooperate with screw threads 1111 on the inner wall of the conduit 105. Two stops 501 are shown in FIG. 11 instead of one, which are placed back-to-back in the conduit 105.

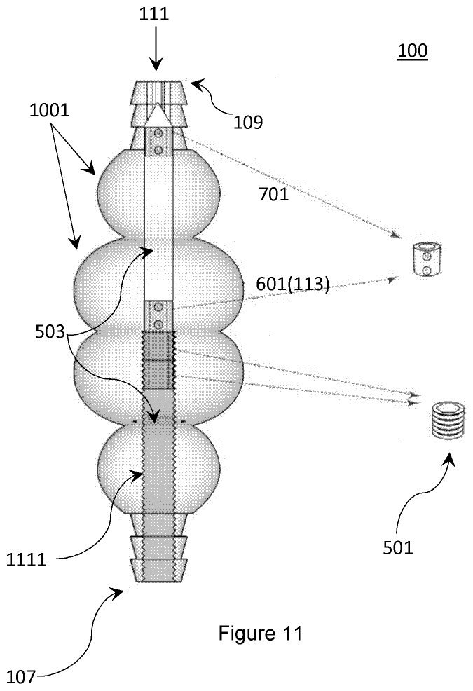

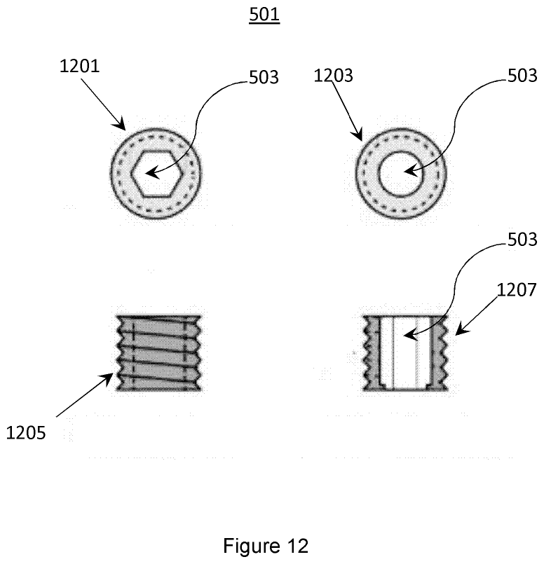

FIG. 12 shows a preferable design of the stop 501 in enlarged view. The top two figures show one end 1201 of the stop 501 and the other end 1203 of the same stop 501. The bottom figure on the left shows a side view 1205 while the bottom figure on the right shows the same side view in cross section 1207. When installed into the atomizer 100, the end of the stop 501 which faces the inlet 107 of the conduit 105 has a hexagonal shaped hole 1201. The hexagonal shaped hole is for fitting to an Alan Key for screwing the stop 501 along the screw threads, as shown in the drawing, until the stop 501 arrives at the intended position inside the conduit 105. The end of the stop 501 which faces the outlet 109 has a round shaped hole 1203. Preferably, the screw threads are provided only on the side of the stop 501 which does not have the movable cylinder 601, so that the scree thread does not interfere with movements of the movable cylinder 601.

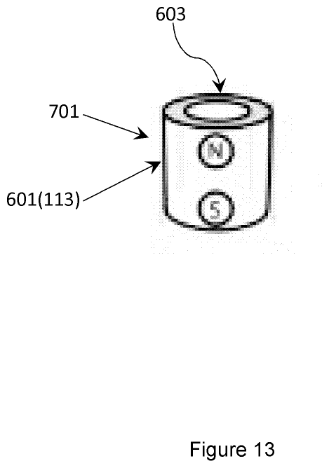

FIG. 13 shows the fixed magnetic cylinder 701 or movable cylinder 601 (the two can be identical objects) used in the atomizer 100 of FIG. 11, in enlarged view. It can be more clearly seen in FIG. 13 that the movable cylinder 601 is a magnet provided in the form of a hollow cylinder, wherein the hollow is a through-hole 603 extending from one end of the cylinder to the other. Fuel 101 is able to pass into the through-hole 603 by one end and emerge the other end of the movable cylinder 601. The polarity of the movable cylinder 601 is illustrated by the letters N for north pole and S for south pole.

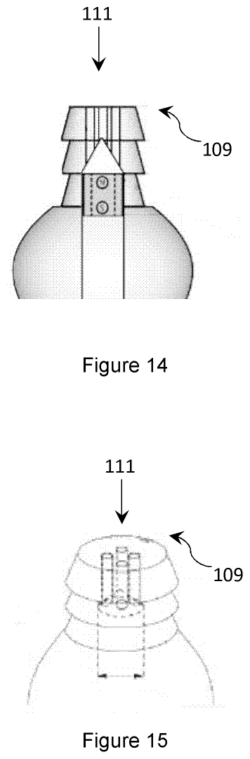

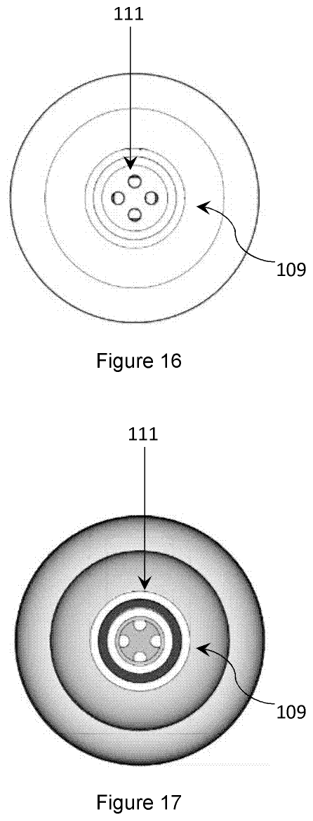

FIG. 14 is an enlarged view of the outlet 109 of the atomizer 100, shown in a shaded cross section and FIG. 15 shows the same part in a line diagram, in the perspective view. The outlet 109 of the conduit 105 tapers into a nozzle 111. FIG. 16 is the plan view looking into the nozzle 111. FIG. 17 is similar to FIG. 16 but rendered to give a 3-dimensional effect. Four holes are shown provided in the nozzle 111 for releasing a spray of fuel mist 103. However, some versions of the nozzle 111 have three holes and other versions have two holes (not illustrated). The less number of holes the higher the pressure of the fuel 101 emerging from the nozzle 111.

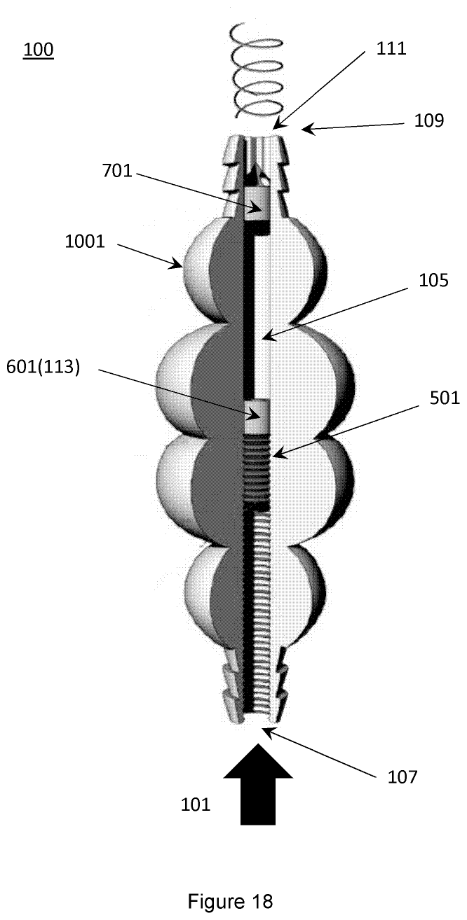

FIG. 18 is a cut-open perspective showing the preferred atomizer 100 of FIG. 11. The top part of FIG. 18 has a line in the form of a screw thread illustrating that atomized fuel emerging from the atomizer 100 is spinning around an axis defined by the direction of the fuel flow. It can be seen that the lower part of the conduit 105 before the stop 501 is lined with spiralling screw threads. As mentioned, the screw thread allows the stop 501 to be screwed into position. However, a further effect of the screw threads is that the screw threads guide the fuel 101 to spin as the fuel moves along in the atomizer 100.

The spinning is typically about an imaginary axis defined by the fuel flow direction. Even when the fuel 101 has squeezed past the hole 503 in the stop 501, and has flowed into the part of the conduit 105 containing the movable cylinder 601, the fuel 101 is still spinning from the effect of the screw threads. The movements of the movable cylinder 601 do not stop the fuel 101 from spinning. The spinning adds to the interaction between the movable cylinder 601 and the moving fuel 101, creating more chaos and turbulence in the fuel inside the atomizer. The fuel 101 is still spinning even when the fuel 101 exits the nozzle 111. As laminar flow is reduced in fuel 101 by spinning, the expelled fuel mist 103 mixes well with air.

Accordingly, when the fuel 101 finally leaves the conduit 105 through the nozzle 111, the fuel 101 has been broken into a very fine mist 103 by the effect of spinning, heat from the engine transferred into the fuel 101, the impact of the movements of the movable cylinder 601, the constriction 503 at the stop 501, the through-hole 603 of the movable cylinder 601, the fixed magnetic cylinder 701, and the nozzle 111.

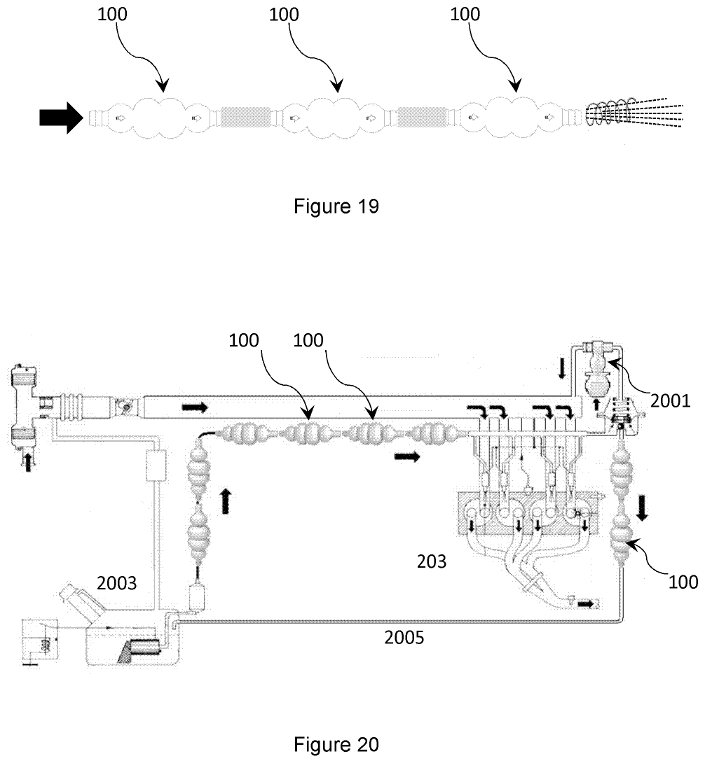

FIG. 19 shows how the preferred atomizer 100 of FIG. 10 may be used in some cases. Depending on the extent of atomization required or preferred, several atomizers 100 may be connected in a series in order to ensure a mist 103 of fuel 101 with finely dispersed molecules. Three atomizers 100 are shown in the drawing, although the number can be greater. Different engines may require more or less atomization of fuel 101 and therefore different number of the atomizers 100 arranged in a series.

FIG. 20 shows six atomizers 100 placed into a series between a fuel tank 2002 and the engine 203, where the output of one of the atomizers 100 becomes the input into another one 100. The atomizer 100 which is last in the series is connected to the engine so that the emerging fuel mist is supplied to the combustion chamber 201 as soon as possible, failing which the atomized fuel mist 103 produced by the atomizer 100 will revert back into a highly liquefied state which will have less mixing efficiency with air.

By providing several atomizers 100 in a series, the fuel 101 flowing through the atomizers 100 is heated more and more by each atomizer 100. By the time the fuel 101 leaves the last one of the atomizer 100, the fuel 101 would have absorbed so much heat, which was transferred to from the heat emitting from the engine, that the fuel 101 is more readily combusted.

On the top right corner of the engine shown in FIG. 20 is a valve 2001 for controlling the supply of air into the manifold directing the air into the combustion chamber 201. The valve 2001 has a shape like a calabash and is made of the same alloy aforementioned as the preferred atomizer 100. The large surface area helps the valve to body to heat up by absorbing heat radiating from the engine, as the engine gets hot when it runs. Air from the surroundings is also sucked into the valve by Venturi effect. In this way, air introduced to mix with the atomized fuel 101 is already pre-heated. Heated air helps to maintain the atomized state of the fuel mist, which further promotes mixing of air and fuel. In contrast, cold air introduced into contact with the fuel most might simply condense the heated atomized fuel 101, causing the fuel mist 103 to revert back into a highly clustered liquefied state.

Therefore, in the combustion chamber 201 of the engine 203 of FIG. 2, finely atomized fuel which is heated and is in a turbulent state is mixed with heated air. This causes the mixture to be potent and readily combustible. If combustion is complete, the engine can remain very clean despite extended use. Exhaust gas from the engine is likely to be more of carbon dioxide and with little or no soot, carbon monoxide or sulphurous compounds. As the virtually homogenous mixture of finely atomized fuel 101 produced by the atomizer 100 is likely to combust completely, the efficient combustion could also burn up eventually any soot or deposits accumulated in the engine caused by inefficient combustion. Therefore, the atomizer 100 is also a cleaning device for cleaning the combustion chamber 201 of the engine.

FIG. 20 also shows use of the atomizer 100 in the return feed 2005; there are two atomizers 100 in the return feed 2005. Fuel 101 which has not been combusted in the combustion chamber 201 is drawn by the atomizers 100 installed into the return feed 2005. Each atomizer 100 causes the return feed fuel 101 to be atomized into a mist 103 which travels more easily without sticking to the wall of the return feed pipe. Furthermore, the atomizer 100 absorbed heat emitting from the engine and transfer the heat to the fuel 101 in the return feed. Without this transfer of heat, the fuel 101 in the return feed may cool off and coagulate into large cluster of fuel 101 which sticks to the wall of the return feed pipe. Therefore, the atomizer 100 helps to heat the fuel 101 in the return feed to move along with greater efficiency.

It has been observed that there is about 33% reduction of non-combusted fuel 101 leaving the combustion chamber 201 using only heat and atomization using fine nozzle 111. However, there is a 66% reduction of non-combusted fuel 101 leaving the combustion chamber 201 using the movable cylinder 601 in the conduit 105.

Generally, a diesel based engine for a car will benefit from a series of six of the atomizers 100, similar to that illustrated in FIG. 20. That is the fuel 101 is heated, atomized and caused to spin by six of the atomizers 100, one after another. However, the chain of atomizers 100 which is suitable for a diesel engine is made up of
a first atomizer 100 with a nozzle 111 having four holes,
followed by another atomizer 100 with a nozzle 111 having four holes,
followed by a third atomizer 100 with a nozzle 111 having four holes,
followed by a fourth atomizer 100 with a nozzle 111 having four holes,
followed by a fifth atomizer 100 with a nozzle 111 having three holes, and
finally followed by a sixth atomizer 100 with a nozzle 111 having only two holes.

This is because when there are more holes in the nozzle 111, the fuel 101 leaving the atomizer 100 spins more but is less pressurised. Just before entering the combustion chamber 201, it is better to use a variation of the atomizer 100 with a lower number of holes in the nozzle 111 in order to increase the pressure of the fuel 101 spraying into the combustion chamber 201, and the fuel's spinning, which will contribute to the mixing of the fuel 101 and air.

Accordingly, the embodiments described are a fuel atomizer 100 comprising a fuel flow path; and an object 113 placed in the fuel flow path; the object 113 arranged to move repeatedly in the fuel 101 during passage of fuel 101. Also, the embodiments included a method of atomizing fuel 101 comprising the step of: moving an orifice 601 for passage of fuel 101 counter-currently to the flow of the fuel 101.

While there has been described in the foregoing description preferred embodiments of the present invention, it will be understood by those skilled in the technology concerned that many variations or modifications in details of design, construction or operation may be made without departing from the scope of the present invention as claimed.

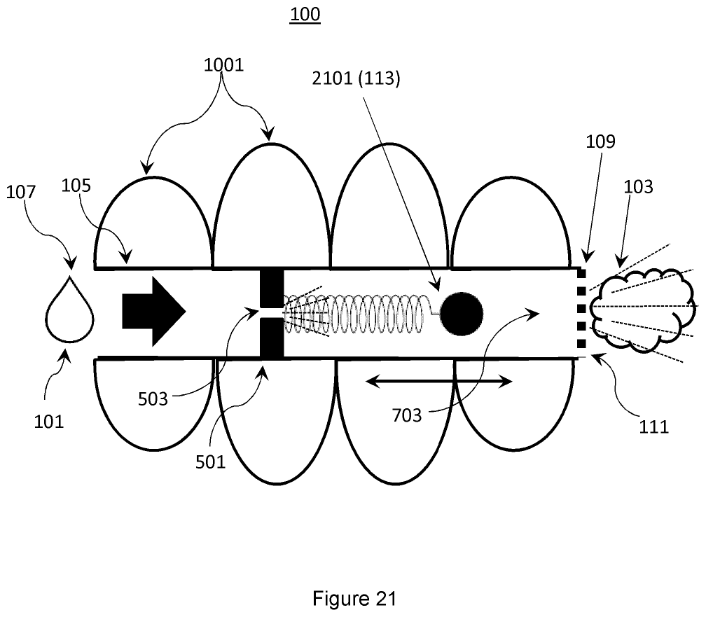

For example, the moving flow-disturbance object 113 may be a bead 2101 and the resilient member is a spring having one end attached to the bead 2101. The other end of the spring is attached to a pre-determined location such as a wall defining the fuel flow path. Accordingly, FIG. 21 shows an embodiment in which a coil spring is used for securing a bead 2101 in the conduit 105. As the fuel 101 carries the bead 2101 along with the fuel flow, the spring is extended. When the spring has been extended a certain length, spring will recoil moving the bead 2101 counter-currently to the flow of the fuel 101. This creates a repetitive disturbance in the conduit 105 as the bead 2101 moves back and forth in the conduit, which helps to break apart the fuel 101 physically.

Although the embodiments mainly describe a flow-disturbance object 113 which is capable of continual, successive, repetitive movements along the path of fuel flow, it is envisaged that movements of the flow-disturbance object 113 may also be across the fuel flow path, diametrically or radially to an axis defined by the direction of fuel flow.

1. A fuel atomizer comprising
a fuel flow path; and
an object placed in the fuel flow path;
the object arranged to move repeatedly in the fuel during passage of fuel.

2. The fuel atomizer as claimed in claim 1, wherein
the object is secured to the conduit by a resilient member.

3. The fuel atomizer as claimed in claim 1, wherein
the object is movable by the flow fuel in one direction and is biased to move counter-currently to the flow of fuel in another direction.

4. The fuel atomizer as claimed in claim 3, wherein
the object is a magnetic device;
the fuel atomizer further comprising
a magnetic field having a polarity directed at the magnetic device to bias the magnetic device to move counter-currently to the flow of fuel.

5. The fuel atomizer as claimed in claim 4, wherein
the magnetic device is a cylinder having a through-hole for passage of fuel through the magnetic device.

6. The fuel atomizer as claimed in claim 4 and claim 5, wherein
the magnetic field is provided by a second magnetic device fixed to the flow path.

7. The fuel atomizer as claimed in claim 5, wherein
the second magnetic device is in the flow path.

8. The fuel atomizer as claimed in claim 5, wherein
the second magnetic device is adjacent the flow path.

9. The fuel atomizer as claimed in claim 1 further comprising flow guides for spinning flowing fuel.

10. The fuel atomizer as claimed in claim 1 further comprising fins for absorbing and directing heat into the fuel flow path.

11. A method of atomizing fuel comprising the steps of:
providing a fuel flow path;
providing a movable object placed in the fuel flow path;
supplying fuel through the fuel flow path; and
repetitively moving the movable object, such that movements of the movable object creates continual flow disturbances in the fuel within the fuel flow path.

12. The method of atomizing fuel as claimed in claim 11, comprising the steps of:
moving the movable object concurrently with the flow of fuel; and
moving the movable object counter-currently to the flow of fuel.

13. The method of atomizing fuel as claimed in claim 12, wherein
the step of moving the movable object counter-currently to the flow of fuel comprises repelling the movable object by a magnetic field.

14. The method of atomizing fuel as claimed in claim 11, further comprising the step of:
spinning the fuel in the fuel flow path.

15. A method of atomizing fuel comprising the step of:
moving an orifice for passage of fuel counter-currently to the flow of the fuel.

16. A combustion engine comprising:
a combustion chamber have an inlet;
an atomizer connected to the inlet; wherein
the atomizer comprises a fuel flow path, and an object placed in the fuel flow path to be continually movable during passage of fuel.

17. A combustion engine comprising:
a combustion chamber have an outlet for residual fuel;
a heated fuel flow path connected to the outlet.

18. A combustion engine comprising:
a combustion chamber have an outlet for residual fuel;
a fuel flow path for returning the residual fuel to a storage connected to the outlet; wherein a fuel atomizer is installed in the fuel flow path.

19. An alloy for the body of an atomizer configured to transfer heat from the surroundings into a fuel to be atomized, the alloy being a zinc and copper alloy comprising 2% to 5% lead.

20. The fuel atomizer as claimed in claim 5, wherein the magnetic field is provided by a second magnetic device fixed to the flow path.

21. The fuel atomizer as claimed in claim 6 further comprising flow guides for spinning flowing fuel.

22. The fuel atomizer as claimed in claim 20 further comprising flow guides for spinning flowing fuel.

23. The fuel atomizer as claimed in claim 6 further comprising fins for absorbing and directing heat into the fuel flow path.

24. The fuel atomizer as claimed in claim 20 further comprising fins for absorbing and directing heat into the fuel flow path.
